(19) United States
(12) Patent Application Publication
(10) Pub. No.: US 2026/0002267 A1
(43) Pub. Date: Jan. 1, 2026

(54) HYDROGEN DETECTION FOR OXYGEN SEPARATOR VESSELS

(71) Applicant: HYAXIOM, INC., East Hartford, CT (US)

(72) Inventor: Sean Foley, Windsor Locks, CT (US)

(21) Appl. No.: 18/756,433

(22) Filed: Jun. 27, 2024

(51) Int. Cl. C25B 1/04; B01D 61/46

(52) U.S. Cl. CPC C25B 1/04; B01D 61/461; B01D 2256/16; B01D 2313/60; B01D 2325/20; B01D 2325/36; B01D 2325/42

(57) ABSTRACT

A system for generating hydrogen may include an electrochemical device and a separator vessel. A hydrogen sensor may be operable to sense hydrogen in a fluid stream communicated from the separator vessel. A method of operating an electrolyzer is also disclosed.

### BACKGROUND

This disclosure relates to electrochemical devices, and more particularly to detecting hydrogen in oxygen separator vessels.

Electrochemical devices may include an electrolyzer adapted to convert water into hydrogen. A return stream including unused water and oxygen may be returned to a separator vessel for reuse. Hydrogen crossover may occur, causing hydrogen to be present in the return stream. A hydrogen sensor may be utilized to detect hydrogen. A condenser may be positioned upstream of a heated sensor to prevent condensation, a sensor may be positioned in an exhaust vent, or a diaphragm pump may actively sample a head space of the separator.

### SUMMARY

A system for generating hydrogen may include an electrochemical device and a separator vessel. A hydrogen sensor may be operable to sense hydrogen in a fluid stream communicated from the separator vessel.

A system for generating hydrogen may include an electrolyzer having an anode, a cathode and a membrane. A separator vessel may include a chamber dimensioned to contain a volume of water, a supply port, a return port, a sample inlet, and/or a sample outlet. A supply line may interconnect the supply port and the anode for conveying water from the chamber. A return line may interconnect the anode and the return port for returning oxygen from the anode. A sample line may interconnect the sample inlet and the sample outlet. A hydrogen sensor may be operable to sense hydrogen in a fluid stream communicated from the chamber through the sample line at a position between the sample inlet and the sample outlet.

A system for generating hydrogen may include an electrolyzer and a separator vessel. A supply line may interconnect an inlet of the electrolyzer and a supply port of the separator vessel. A return line may interconnect an outlet of the electrolyzer and a return port of the separator vessel. A sample line may include a sample inlet and a sample outlet that may be coupled to a head space of the separator vessel. A hydrogen concentration sensor may be operable to sense hydrogen in a fluid stream communicated from the head space through the sample line at a position that may be between the sample inlet and the sample outlet. A control may be coupled to the hydrogen concentration sensor. The control may be operable to cause the electrolyzer to shut down in response to a hydrogen concentration in the sample line exceeding a preselected threshold.

A method of operating an electrolyzer may include communicating water from a separator vessel to an anode inlet of an electrolyzer. The method may include returning oxygen from an anode outlet of the electrolyzer to the separator vessel. The method may include communicating fluid from a head space of the separator vessel to a sample line. The method may include determining, using a hydrogen concentration sensor, a hydrogen concentration of the fluid in the sample line. The method may include returning the sampled fluid in the sample line back to the head space at a position downstream of the hydrogen concentration sensor.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

Various features and advantages of at least one disclosed example embodiment will become apparent to those skilled in the art from the following detailed description. The drawing that accompanies the detailed description can be briefly described as follows.

### BRIEF DESCRIPTION OF THE DRAWINGS

FIG. 1 discloses a system including an electrochemical device coupled to a separator vessel.

FIG. 2 discloses a system including an electrochemical device coupled to a separator vessel according to another implementation.

FIG. 3 discloses a method for operating an electrochemical device.

Like reference numbers and designations in the various drawings indicate like elements.

### DETAILED DESCRIPTION

Systems designed according to the techniques disclosed herein may be useful for generating hydrogen that can be used for a variety of purposes. The disclosed systems may include one or more electrochemical devices, such as an electrolyzer that uses electricity to convert water into hydrogen.

The electrochemical device may be coupled to a separator vessel (e.g., tank). A sample line may be coupled to the separator vessel for sampling gasses in the separator vessel. Gasses may be sampled at a relatively high position in the separator vessel where hydrogen may be more likely to collect, such as along a top of a head space of the separator vessel. A hydrogen concentration sensor may be operable to sense hydrogen in the sample line. A sample pump may be utilized to communicate fluid through the sample line. The sample pump may include an active or passive pump configuration. The sample pump may include an ejector, which may be powered by a pressurized stream of fluid. The pressurized stream may be communicated from an anode circulation pump. The ejector may draw a negative pressure and corresponding flow of oxygen gas through the sample line to the hydrogen sensor. The sample line may include a sample inlet positioned along the head space of the separator vessel such that any hydrogen-bearing streams may be nearby to improve early detection of any hydrogen accumulations. The sample inlet may be positioned adjacent a water/oxygen return line from the electrochemical cell. In implementations, the sample inlet may be positioned adjacent a line returning water that has undergone electro-osmotic drag into a cathode of the electrochemical device. The sampled fluid may be recycled back to the separator vessel.

An operating mode of the system may be set based on the determined hydrogen concentration level. In implementations, the electrochemical device may enter an offline (e.g., shutdown) mode in response to the determined hydrogen concentration level exceeding a preselected threshold or hydrogen otherwise being present.

A system for generating hydrogen may include an electrolyzer having an anode, a cathode and a membrane. A separator vessel may include a chamber dimensioned to contain a volume of water, a supply port, a return port, a sample inlet, and/or a sample outlet. A supply line may interconnect the supply port and the anode for conveying water from the chamber. A return line may interconnect the anode and the return port for returning oxygen from the anode. A sample line may interconnect the sample inlet and the sample outlet. A hydrogen sensor may be operable to sense hydrogen in a fluid stream communicated from the chamber through the sample line at a position between the sample inlet and the sample outlet.

In any implementations, a sample pump may be disposed in the sample line.

In any implementations, the sample pump may be an ejector.

In any implementations, the ejector may include a first inlet, a second inlet, and an outlet. The first inlet may be coupled to the sample line. The second inlet may be coupled to a feed line such that flow through the feed line may serve as a motive force for conveying the fluid stream from the first inlet to the outlet of the sample pump and then to the sample outlet.

In any implementations, a circulation pump may be disposed in the supply line.

In any implementations, the feed line may branch from the supply line at a position between an outlet of the circulation pump and an inlet of the anode.

In any implementations, the sample inlet and the sample outlet may be disposed along a head space of the chamber.

In any implementations, the separator vessel may include a vent disposed along the head space at a position spaced apart from the sample inlet and the sample outlet.

In any implementations, the sample line may include at least one humidity exchanger.

In any implementations, the at least one humidity exchanger may include a selectively porous hydrophilic material that may absorb water in the sample line, but may permit passage of hydrogen and oxygen through the sample line.

In any implementations, the electrolyzer may be a proton exchange membrane (PEM) electrolyzer.

A system for generating hydrogen may include an electrolyzer and a separator vessel. A supply line may interconnect an inlet of the electrolyzer and a supply port of the separator vessel. A return line may interconnect an outlet of the electrolyzer and a return port of the separator vessel. A sample line may include a sample inlet and a sample outlet that may be coupled to a head space of the separator vessel. A hydrogen concentration sensor may be operable to sense hydrogen in a fluid stream communicated from the head space through the sample line at a position that may be between the sample inlet and the sample outlet. A control may be coupled to the hydrogen concentration sensor. The control may be operable to cause the electrolyzer to shut down in response to a hydrogen concentration in the sample line exceeding a preselected threshold.

In any implementations, an ejector may be disposed in the sample line downstream of the hydrogen concentration sensor.

In any implementations, the ejector may be coupled to a feed line that may branch from the supply line to provide a motive force for returning the fluid stream to the head space.

A method of operating an electrolyzer may include communicating water from a separator vessel to an anode inlet of an electrolyzer. The method may include returning oxygen from an anode outlet of the electrolyzer to the separator vessel. The method may include communicating fluid from a head space of the separator vessel to a sample line. The method may include determining, using a hydrogen concentration sensor, a hydrogen concentration of the fluid in the sample line. The method may include returning the sampled fluid in the sample line back to the head space at a position downstream of the hydrogen concentration sensor.

In any implementations, the method may include causing the electrolyzer to shut down in response to the determined hydrogen concentration exceeding a preselected threshold.

In any implementations, the returning step may include communicating a motive stream from a feed line to an ejector to provide a motive force for returning the sampled fluid in the sample line back to the head space.

In any implementations, the step of communicating the water may include pressurizing the water in a supply line between the separator vessel and the anode inlet. The step of communicating the motive stream may include diverting a portion of the pressurized water from the supply line to the feed line.

In any implementations, the method may include absorbing water in the sample line with at least one humidity exchanger at a position upstream of and/or adjacent to the hydrogen concentration sensor.

In any implementations, the sample line may interconnect a sample inlet and a sample outlet along the head space. The method may include venting gas from a vent outlet at a position along the head space that is spaced apart from the sample inlet and the sample outlet.

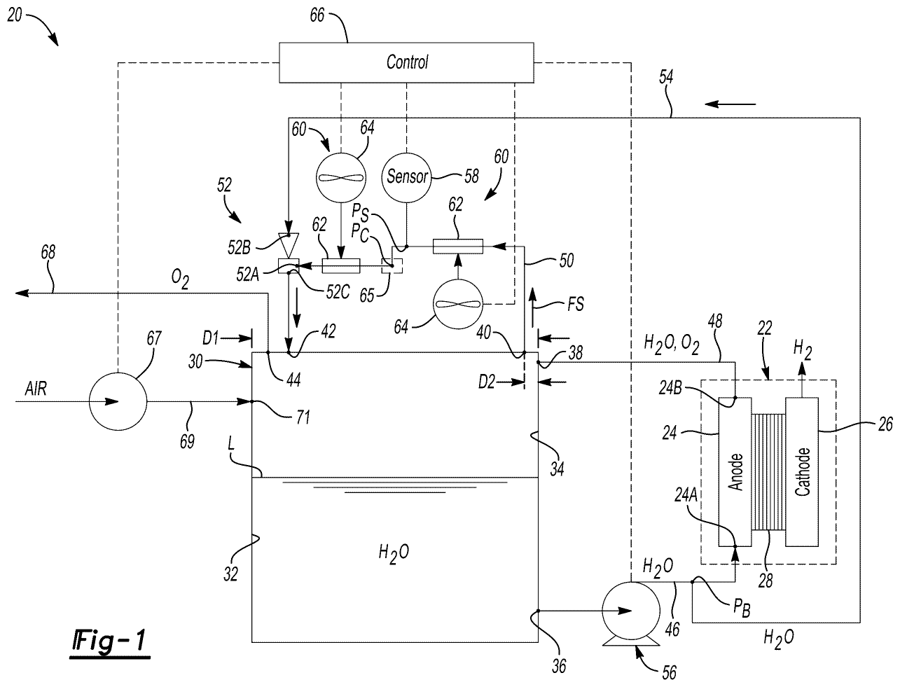

FIG. 1 discloses a system 20 for generating hydrogen according to an implementation. The system 20 may include one or more electrochemical devices 22. In implementations, the electrochemical device 22 may include an electrolyzer. The electrolyzer may include an anode electrode 24, a cathode electrode 26 and/or an electrolyte 28. The anode 24 and cathode 26 may be on opposite sides of the electrolyte 28. The electrolyte 28 may be a solid or liquid acid electrolyte contained in a matrix that serves as a membrane. In implementations, the electrolyzer 22 may be a proton exchange membrane (PEM) electrolyzer. Other electrolyzers may be utilized in accordance with the teachings disclosed herein, such as an electrolyzer including an alkaline or anion exchange membrane. The system 20 may include two or more electrochemical devices 22 arranged in a stack or assembly.

In operation, an amount of water (H₂O) may be communicated to the anode 24. A chemical reaction may occur such that the cathode 26 may produce an amount of hydrogen (H₂). The hydrogen may be stored for later usage. The anode 24 may be adapted to generate exhaust in the form of unused water and oxygen (O₂). A fluid stream including the unused water and oxygen may be communicated from the anode 24 to the separator vessel 30 for separation of oxygen from water prior to recirculating the water back to the anode 24. In scenarios, the fluid stream from the anode 24 may include an amount of hydrogen associated with hydrogen crossover at the membrane. Crossover may occur due to membrane thinning, which may be caused by degradation of the electrochemical device 22. Some potential causes of degradation may include the presence of cation impurities in the water feed, operating with suboptimal mechanical stress distributions and/or temperature transients from power cycles.

The system 20 may include at least one (e.g., oxygen) separator vessel 30. Various separator vessels 30 may be utilized, such as a tank. The separator vessel 30 may include a chamber 32 dimension to contain a volume of water. The separator vessel 30 may include a volume associated with a head space 34. The head space 34 may be established above a water level (e.g., line) L of the chamber 32. Implementations, the separator vessel 30 may include one or more ports (e.g., inlets and/or outlets) for communicating fluid between the chamber 32 and other portions of the system 20, including the electrochemical device 22. In the implementation of FIG. 1, the system 20 may include a supply port 36, a return port 38, a sample inlet 40, a sample outlet 42 and/or a vent outlet 44.

The system 20 may include one or more lines (e.g., conduits) dimensioned to establish a respective flow path. The conduits may include a supply line 46, a return line 48, a sample line 50 and/or a feed line 54. The supply line 46 may be adapted to interconnect an inlet of the electrochemical device 22 and the supply port 36 of the separator vessel 30. In implementations, the supply line 46 may be adapted to interconnect the supply port 36 and an anode inlet 24A of the anode 24 for conveying water from the chamber 32. The return line 48 may be adapted to interconnect an outlet of the electrolyzer 22 and the return port 38 of the separator vessel 30. In implementations, the return line 48 may be adapted to interconnect an anode outlet 24B of the anode 24 and the return port 38 for returning unused water and/or oxygen from the anode 24. The unused water may be communicated back to the anode 24.

The system 20 may include an (e.g., anode) circulation pump 56. The circulation pump 56 may be disposed in the supply line 46. The circulation pump 56 may be adapted to pressurize water communicating from the chamber 32 through the supply line 46. The feed line 54 may branch from the supply line 46 at a position PB between an outlet of the circulation pump 56 and the anode inlet 24A.

The sample line 50 may be adapted to interconnect the sample inlet 40 and the sample outlet 42. The system 20 may include a sample pump 52 disposed in the sample line 50. The sample pump 52 may be adapted to communicate flow through the sample line 50. Various pumps may be utilized, including active and passive pump configurations. In implementations, the sample pump 52 may be an ejector. The ejector 52 may include a first inlet 52A, a second inlet 52B, and/or an outlet 52C. The first inlet 52A may be coupled to a first section of the sample line 50. The outlet 52C may be coupled to a second section of the sample line 50. The second inlet 52B may be coupled to the feed line 54. Flow of pressurized water through the feed line 54 may serve as a motive force for conveying a fluid stream FS in the supply line 50 from the first inlet 52A to the outlet 52C of the sample pump 52 and then to the sample outlet 42. The feed line 54 may branch from the supply line 46 to provide a motive force for returning the fluid stream FS to the head space 34 of the separator vessel 30. The ejector 52 may include no moving parts and be operated using less than about 1% of pressurized flow diverted from the circulation pump 56, which may improve efficiency and reliability of the system 20. The term “about” means ±0.25% of the stated value or relationship unless otherwise indicated.

The system 20 may include at least one hydrogen concentration sensor 58. The sensor 58 may be operable to detect (e.g., sense) hydrogen which may be caused by hydrogen crossover in the electrochemical device 22. The sensor 58 may be operable to sense hydrogen in the fluid stream FS communicated from the head space 34 of the chamber 32 through the sample line 50. In implementations, the sensor 58 may be operable to sense hydrogen in the fluid stream FS at a position PS between the sample inlet 40 and the sample outlet 42. The position PS may be along the sample line 50 and may be spaced apart from the sample inlet 40 and/or the sample outlet 42. In other implementations, the position PS may be at the sample inlet 40 or the sample outlet 42. The sample pump 52 may be disposed in the sample line 50 downstream of the hydrogen concentration sensor 58.

The sample inlet 40 and/or the sample outlet 42 may be disposed along, or may otherwise be coupled to, the head space 34 of the chamber 32. In implementations, the sample inlet 40 and/or the sample outlet 42 may be positioned above a position of the return port 38 (e.g., relative to the water level L). The sample inlet 40 may be adjacent to the return port 38, which may provide a relatively early indication (e.g., detection) of hydrogen in the return line 48 caused by hydrogen crossover in the electrochemical device 22. The chamber 32 may be dimensioned to span a first distance (e.g., width) D1 at the return port 38. The sample inlet 40 may be established at a second distance D2 from the return port 38. In implementations, a ratio of D2:D1 may be less than or equal to 1:4, or more narrowly less than or equal to 1:10, which may facilitate early detection of hydrogen in the return line 48. The system 20 may be adapted to execute one or more corrective actions relatively sooner to maintain the electrochemical device 22 within defined operating limits based on the early hydrogen detection.

The system 20 may include at least one or more humidity exchangers 60. Each humidity exchanger 60 may be disposed in the sample line 50. The humidity exchanger 60 may establish a respective segment 62 of the sample line 50. The segment 62 may be established by a selectively porous hydrophilic material. The hydrophilic material may be adapted to absorb water in the sample line 50, but may permit passage of gasses such as hydrogen and/or oxygen through the sample line 50. Various hydrophilic materials may be utilized, such as a sulfonated tetrafluoroethylene based fluoropolymer-copolymer sold under the trade name Nafion™. The material may establish an (e.g., tubular) conduit, or the material may be a coating applied to a conduit. The hydrophilic material may allow water to diffuse out of the saturated oxygen, which may result in a stream (e.g., significantly) below dew point and may reduce a likelihood of damage to the sensor 58. Each humidity exchanger 60 may include a circulation device (e.g., fan) 64 for conveying airflow across the segment 62 of the humidity exchanger 60. The system 20 may include humidity exchangers 60 adjacent to and/or on opposite sides (e.g., upstream, downstream) of the hydrogen sensor 58. In implementations, either (or both) of the humidity exchangers 60 may be omitted. In other implementations, a check valve 65 (shown in dashed lines) may be positioned in the sample line 50 at position P_{C} downstream of the sensor 58. The check valve 65 may be positioned between the sensor 58 and the sample pump 52 to block reverse flow of water (e.g., liquid and/or vapor) from being communicated to the sensor 58. The disclosed techniques may reduce a likelihood of water condensing on the sensor 58.

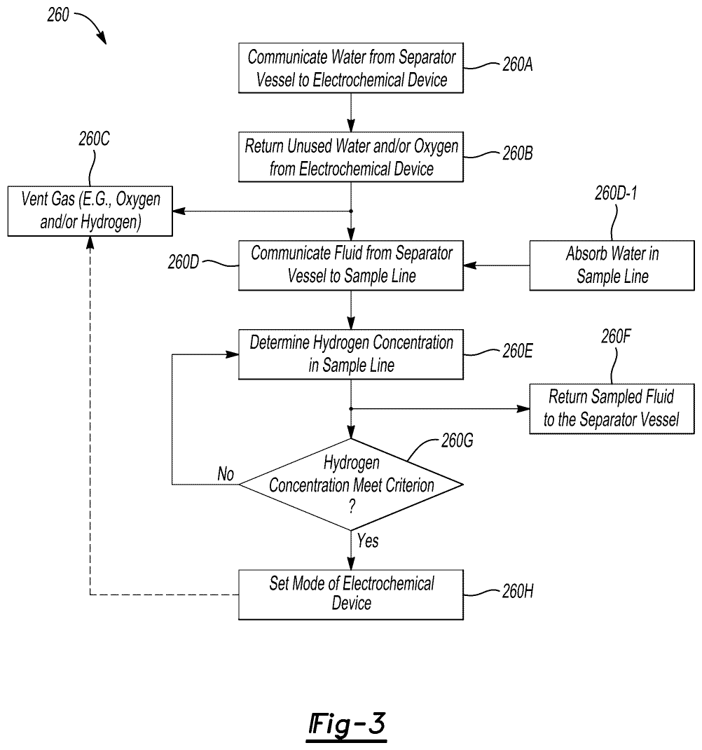

The system 20 may include a control 66. The control 66 may adapted to control one or more devices of the system 20, including operation of the electrochemical device 22. The control 66 may include one or more analog and/or digital components. The control 66 may include one or more processors, memory and/or interfaces. The processor(s) may be any type of known processor or microprocessor having desired performance characteristics. The memory may include UVPROM, EEPROM, FLASH, RAM, ROM, DVD, CD, a hard drive, or other computer readable medium which may store data and the method 260 (FIG. 3) for operation of the control 66. The processor(s) of the control 66 may be collectively operable to execute one or more instructions to implement any of the functionality disclosed herein.

The control 66 may be coupled to, and may be operable to modulate or otherwise control, one or more devices of the system 20. The devices may include the circulation pump 56, one or more circulation devices 64, 67, etc. The control 66 may be operable to modulate or otherwise control operation of the circulation device(s) 64, 67.

The control 66 may be coupled to one or more sensors, such as the hydrogen concentration sensor 58. The controller 66 may be operable to receive information including one or more sensed conditions from the sensor(s). The control 66 may be operable to receive, from the hydrogen sensor 58, information including an indication of a presence, amount and/or concentration of hydrogen in the fluid stream FS through the sample line 50. The control 66 may be operable to determine, from the sensed information, a presence, amount and/or concentration of hydrogen in the fluid stream FS through the sample line 50.

The control 66 may be operable to cause the system 20 to operate in one or more operating modes based on a concentration of hydrogen in the sample line 50. The modes of the system 20 may include a first mode, a second mode and/or a third mode. The third mode may be associated with normal (e.g., hydrogen producing) operation of the electrochemical device 22.

The first mode may be associated with a first preselected threshold. The second mode may be associated with a second preselected threshold, which may be greater than the first preselected threshold. The first and/or second preselected thresholds may be associated with respective hydrogen concentration levels. The first threshold may be a presence of any hydrogen in the sampled fluid. The first threshold may be greater than 0% hydrogen concentration (e.g., greater than 0.25%), but may be less than or equal to about 1% hydrogen concentration. The second threshold may be about 1.25% hydrogen concentration, or more narrowly may be about 2% hydrogen concentration. The threshold(s) may be specified by ISO Standard 22734. The control 66 may be operable to compare the determined hydrogen concentration to the preselected threshold(s). The system 20 may be operable in fewer or more than three modes. In implementations, the second or third mode may be omitted.

The separator vessel 30 may be coupled to an exhaust vent 68. The vent 68 may be disposed along the head space 34 at a position spaced apart from the sample inlet 40 and/or the sample outlet 42. The vent 68 may be adapted to communicate (e.g., purge or ventilate) gasses such as oxygen from the head space 34 to atmosphere or a recapture device. A circulation device 67 (e.g., blower, vacuum pump, fan, etc.) may be disposed in a delivery (e.g., feed) line 69. The delivery line 69 may be coupled to a delivery port 71 along the head space 34 of the separator vessel 30. The circulation device 67 may be operable to deliver a gas such as external air (e.g., under slightly increased pressure) into the head space 34. The delivered air may displace and/or dilute any potentially flammable gases including hydrogen from the head space 34 through the vent 68 (e.g., into the surrounding atmosphere). Other diluting gas sources (e.g., nitrogen bottles) may be utilized to displace and/or dilute gasses in the head space 34.

The control 66 may be operable to cause the electrochemical device 22 to operate in the first mode in response to the hydrogen concentration in the sample line 50 exceeding the first threshold (e.g., but not the second threshold). The first mode may be associated with a reduced operational state and/or corrective measure. Corrective measures may include ventilating (e.g., purging) gasses from the head space 34. The gasses may be ventilated through the vent 68 to reduce hydrogen in the separator vessel 30. The control 66 may be operable to vary (e.g., increase) a rate of flow through the circulation device 67 to dilute, displace and/or ventilate gasses in the head space 34, including any hydrogen that may be caused by hydrogen crossover in the electrochemical device 22.

The control 66 may be operable to cause the electrochemical device 22 to operate in the second (e.g., offline or shutdown) mode in response to the hydrogen concentration in the sample line 50 exceeding the second threshold. The control 66 may be operable to cause the electrochemical device 22 to shut down in the second mode. The control 66 may be operable to block (e.g., normal) operation of the electrochemical device 22 unless the hydrogen concentration is less than the first threshold and/or the second threshold. In implementations, the second mode may be a lockout shutdown mode which may preclude an override.

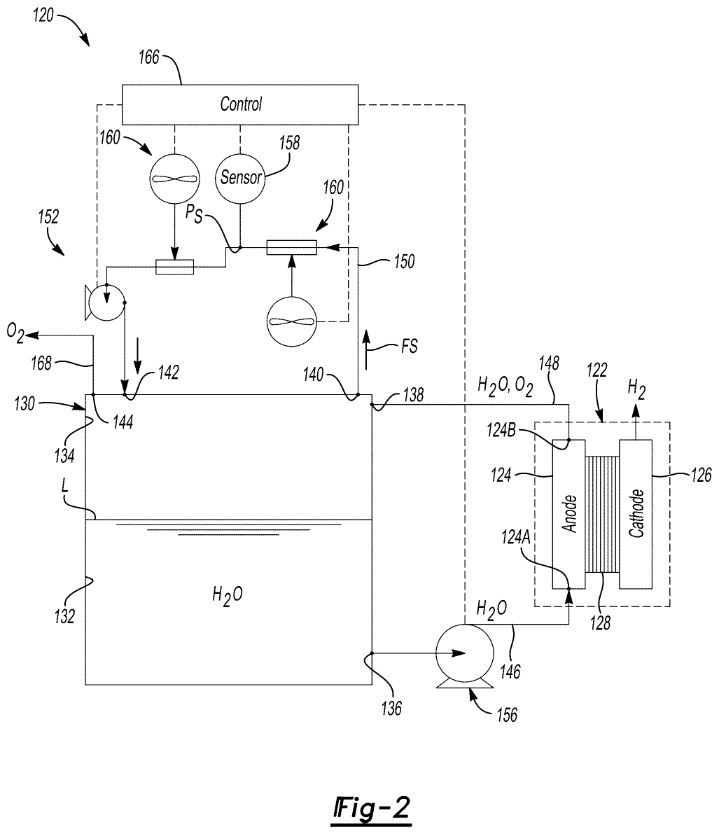

FIG. 2 discloses a system 120 for generating hydrogen according to another implementation. In this disclosure, like reference numerals designate like elements where appropriate and reference numerals with the addition of one-hundred or multiples thereof designate modified elements that are understood to incorporate the same features and benefits of the corresponding original elements. In the implementation of FIG. 2, the feed line 54 may be omitted. The system 120 may include a sample pump 152. The sample pump 152 may include various active and/or passive pump configurations, such as a vacuum pump. The pump 152 may be operable to communicate flow of a fluid stream FS through a sample line 150. A control 166 may be coupled to the pump 152. The control 166 may be operable to modulate or otherwise control the pump 152. The pump 152 may be operable to cause a continuous fluid stream to pass across the sensor 158.

FIG. 3 discloses a method of operating an electrochemical device in a flowchart 260 according to an implementation. The electrochemical device may include any of the devices disclosed herein, such as an electrolyzer. The method 260 may be useful for detecting hydrogen crossover in the electrochemical device. Fewer or additional steps than are recited below could be performed within the scope of this disclosure, and the recited order of steps is not intended to limit this disclosure. The control 66/166 may be operable to perform any of the functionality of the method 260. Reference is made to the system 20 of FIG. 1, although the method 260 may also be utilized to operate the system 120 of FIG. 2.

At block 260A, water may be communicated from the separator vessel 30 to the anode inlet 24A of the electrolyzer 22. Block 260A may include pressurizing water in the supply line 46 between the separator vessel 30 and the anode inlet 24A of the electrochemical device 22. At block 260B, unused water and/or oxygen may be returned from the anode outlet 24B of the electrolyzer 22 to the separator vessel 30.

In implementations, the method 260 may include venting gas (e.g., oxygen and/or hydrogen) from the head space 34 of the separator vessel 30 at block 260C. The gas may be vented from the vent outlet 44 at a position along the head space 34 that may be spaced apart from the sample inlet 40 and/or the sample outlet 44. Block 260C may include causing the circulation device 67 to deliver external air into the head space 34, which may displace and/or dilute any potentially flammable gasses from the head space 34 through the vent 68.

Fluid (e.g., oxygen gas) may be communicated from the head space 34 of the separator vessel 30 to the sample line 50 at block 260D. The sample line 50 may interconnect the sample inlet 40 and the sample outlet 42 along the head space 34. In implementations, communicating the fluid may include absorbing water in the sample line 50 at block 260D-1. Water in the sample line 50 may be absorbed with one or more humidity exchangers 60. Water may be absorbed with the humidity exchanger 60 at a position upstream, downstream and/or otherwise adjacent to the hydrogen concentration sensor 58. The sample pump 52 may communicate the fluid through the sample line 50. The sample pump 52 may be an ejector. In the implementation of FIG. 2, the sample pump 152 may communicate the fluid through the sample line 150.

At block 260E, a hydrogen concentration of the fluid in the sample line 50 may be determined (e.g., sensed) using the hydrogen concentration sensor 58.

At block 260F, the sampled fluid in the sample line 50 may be returned to the head space 34. The sampled fluid may be returned to the head space 34 at a position downstream of the hydrogen concentration sensor 58. Block 260F may include communicating a motive stream from the feed line 54 to the ejector 52 to provide a motive force for returning the sampled fluid in the sample line 50 back to the head space 34 of the separator vessel 30. Communicating the motive stream may include diverting a portion of the pressurized water from the supply line 46 to the feed line 54.

At block 260G, the determined (e.g., sensed) hydrogen concentration may be compared to one or more criterion. Block 260G may be repeated for one or more iterations, including in response to the hydrogen concentration not meeting the criterion. The criterion may include the hydrogen concentration exceeding one or more (e.g., preselected) thresholds.

At block 260H, an operating mode of the electrochemical device 22 may be set (e.g., changed) in response to the one or more criterion being met. The operating modes may include any of the modes disclosed herein. Block 260H may include blocking (e.g., normal) operation of the electrochemical device 22 unless the hydrogen concentration is less than one or more preselected thresholds, including any of the thresholds disclosed herein. Block 260H may include causing the electrochemical device 22 to shut down in response to the determined hydrogen concentration meeting the one or more criterion, such as exceeding a preselected threshold, including any of the thresholds disclosed herein.

Any of the blocks of the method 260 may be repeated for one or more iterations during operation of the system 20. Method 260 may include transitioning the system 20 from normal operation to the shutdown mode.

The novel devices and methods of this disclosure may reliably and quickly detect hydrogen in separator vessels, which may be caused by hydrogen crossover in an electrochemical device. The disclosed system may utilize an ejector motive pressure stream to sample gasses in the separator vessel for hydrogen. The systems may incorporate an (e.g., anode) circulation pump to supply pressured water to the electrochemical device, which may improve efficiency since diffused hydrogen may be present in the return line when the circulation pump may be operating. The disclosed techniques may reduce complexity and material cost, including additional controls or hardware to monitor hydrogen concentration levels. The disclosed techniques may avoid the need to run additional powered ancillary equipment (e.g., diaphragm pumps), which may improve reliability in sensor operation and reduce power consumption. Incorporating a selectively porous hydrophilic material in the sample line to protect the hydrogen sensor may reduce the need for a condenser or heater to remove water from the sample line, which may improve reliability, the amount of hardware and system parasitic loads.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should further be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed:

1. A system for generating hydrogen comprising:
an electrolyzer including an anode, a cathode and a membrane;
a separator vessel including a chamber dimensioned to contain a volume of water, a supply port, a return port, a sample inlet, and a sample outlet, wherein a supply line interconnects the supply port and the anode for conveying water from the chamber, a return line interconnects the anode and the return port for returning oxygen from the anode, and a sample line interconnects the sample inlet and the sample outlet; and
a hydrogen sensor operable to sense hydrogen in a fluid stream communicated from the chamber through the sample line at a position between the sample inlet and the sample outlet.

2. The system as recited in claim 1, further comprising a sample pump disposed in the sample line.

3. The system as recited in claim 2, wherein the sample pump is an ejector.

4. The system as recited in claim 3, wherein:
the ejector includes a first inlet, a second inlet, and an outlet;
the first inlet is coupled to the sample line;
the second inlet is coupled to a feed line such that flow through the feed line serves as a motive force for conveying the fluid stream from the first inlet to the outlet of the sample pump and then to the sample outlet.

5. The system as recited in claim 4, further comprising:
a circulation pump disposed in the supply line.

6. The system as recited in claim 5, wherein:
the feed line branches from the supply line at a position between an outlet of the circulation pump and an inlet of the anode.

7. The system as recited in claim 1, wherein:
the sample inlet and the sample outlet are disposed along a head space of the chamber.

8. The system as recited in claim 7, wherein:
the separator vessel includes a vent disposed along the head space at a position spaced apart from the sample inlet and the sample outlet.

9. The system as recited in claim 1, wherein:
the sample line includes at least one humidity exchanger.

10. The system as recited in claim 9, wherein:
the at least one humidity exchanger includes a selectively porous hydrophilic material that absorbs water in the sample line, but permits passage of hydrogen and oxygen through the sample line.

11. The system as recited in claim 1, wherein:
the electrolyzer is a proton exchange membrane (PEM) electrolyzer.

12. A system for generating hydrogen comprising:
an electrolyzer;
a separator vessel;
a supply line that interconnects an inlet of the electrolyzer and a supply port of the separator vessel;
a return line that interconnects an outlet of the electrolyzer and a return port of the separator vessel;
a sample line including a sample inlet and a sample outlet coupled to a head space of the separator vessel;
a hydrogen concentration sensor operable to sense hydrogen in a fluid stream communicated from the head space through the sample line at a position between the sample inlet and the sample outlet; and
a control coupled to the hydrogen concentration sensor, wherein the control is operable to cause the electrolyzer to shut down in response to a hydrogen concentration in the sample line exceeding a preselected threshold.

13. The system as recited in claim 12, further comprising an ejector disposed in the sample line downstream of the hydrogen concentration sensor.

14. The system as recited in claim 13, wherein:
the ejector is coupled to a feed line that branches from the supply line to provide a motive force for returning the fluid stream to the head space.

15. A method of operating an electrolyzer comprising:
communicating water from a separator vessel to an anode inlet of an electrolyzer;
returning oxygen from an anode outlet of the electrolyzer to the separator vessel;
communicating fluid from a head space of the separator vessel to a sample line;
determining, using a hydrogen concentration sensor, a hydrogen concentration of the fluid in the sample line; and
returning the sampled fluid in the sample line back to the head space at a position downstream of the hydrogen concentration sensor.

16. The method as recited in claim 15, further comprising:
causing the electrolyzer to shut down in response to the determined hydrogen concentration exceeding a preselected threshold.

17. The method as recited in claim 15, wherein the returning step comprises:
communicating a motive stream from a feed line to an ejector to provide a motive force for returning the sampled fluid in the sample line back to the head space.

18. The method as recited in claim 17, wherein:
the step of communicating the water includes pressurizing the water in a supply line between the separator vessel and the anode inlet; and
the step of communicating the motive stream includes diverting a portion of the pressurized water from the supply line to the feed line.

19. The method as recited in claim 15, further comprising:
absorbing water in the sample line with at least one humidity exchanger at a position upstream of and/or adjacent to the hydrogen concentration sensor.

20. The method as recited in claim 15, wherein the sample line interconnects a sample inlet and a sample outlet along the head space, and further comprising:
venting gas from a vent outlet at a position along the head space that is spaced apart from the sample inlet and the sample outlet.
